(19) United States
(12) Patent Application Publication
(10) Pub. No.: US 2005/0166738 A1
(43) Pub. Date: Aug. 4, 2005

(54) Wrap film cutting apparatus

(75) Inventor: Chia-Ti Hsu, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Sinopacker International Inc., Taichung City (TW)

(21) Appl. No.: 10/825,307

(22) Filed: Apr. 16, 2004

(30) Foreign Application Priority Data
Feb. 4, 2004 (TW) 93201572

(51) Int. Cl. B26D 1/06

(52) U.S. Cl. 83/614; 83/649

(57) ABSTRACT

A wrap film cutting apparatus includes a guide rail and a sliding cutter slidably mounted on the guide rail. The sliding cutter is provided with a blade mounted therein covertly. The guide rail is covered with an attractive layer made of a polymeric material at a top surface thereof for attracting a wrap film to be cut. Accordingly, the wrap film cutting apparatus can facilitate smooth cutting action to further enhance convenience for the user.

### BACKGROUND OF THE INVENTION

1. Field of the Invention

The present invention relates generally to wrap film cutting apparatuses, and more particularly to an improved wrap film cutting apparatus, which can quickly smooth a wrap film to further enhance the convenience of using the apparatus.

2. Description of the Related Art

A conventional wrap film cutting apparatus 1, as shown in FIG. 1, is mounted on a wrap film dispenser A and is composed of a guide rail 2 and a sliding cutter 3 slidably mounted on the guide rail 2. The guide rail 2 is mounted on an external side of the wrap film dispenser A. When the user intends to acquire a piece of wrap film, the user firstly pulls the wrap film B out of the dispenser A, lays the wrap film B smoothly on the guide rail 2, and then pushes the sliding cutter 3 through the wrap film B, and meanwhile, a blade (not shown) covertly mounted in the sliding cutter 3 cuts the wrap film B.

However, the guide rail 2 has a smooth surface to hardly incur any attraction between the wrap film B and the surface of the guide rail 2, such that while cutting the wrap film B, the wrap film B is subject to wrinkle to reduce the smoothness of the cutting action and to further incur inconvenience for the user.

Although mounting a plurality of rollers on the sliding cutter may puzzle out the above mentioned problem, it increases the production cost of the sliding cutter. In addition, a gap between the rollers and the surface of the guide rail must be kept within a fixed range of smallness for the little thinness of the wrap film, and once the gap is too large, the wrap film B will be kept ineffectively smooth.

### SUMMARY OF THE INVENTION

The primary objective of the present invention is to provide a wrap film cutting apparatus, which can quickly and effectively smooth wrap film and facilitate smooth cutting action to further enhance convenience for the user.

The secondary objective of the present invention is to provide a wrap film cutting apparatus, which is structurally simple to effectively reduce production cost.

The foregoing objectives of the present invention are attained by the wrap film cutting apparatus, which includes a guide rail and a sliding cutter slidably mounted on the guide rail. The sliding cutter is provided with a blade mounted therein covertly. The guide rail is covered with an attractive layer made of a polymeric material at a top surface thereof for attracting a wrap film to be cut. Accordingly, the wrap film cutting apparatus can facilitate smooth cutting action to further enhance convenience for the user.

Preferably, the polymeric material is selected from the group consisting of PVC (polyvinyl chloride), PE (polyethylene), PP (polypropylene), EVA (ethylene vinyl acetate), and ABS (acrylonitrile butadiene styrene).

### BRIEF DESCRIPTION OF THE DRAWINGS

FIG. 1 is a perspective view of the prior art;

FIG. 2 is an exploded view of a preferred embodiment of the present invention;

FIG. 3 is a sectional view of the preferred embodiment of the present invention; and

FIG. 4 is a schematic view of the preferred embodiment of the present invention mounted on a wrap film dispenser in operation.

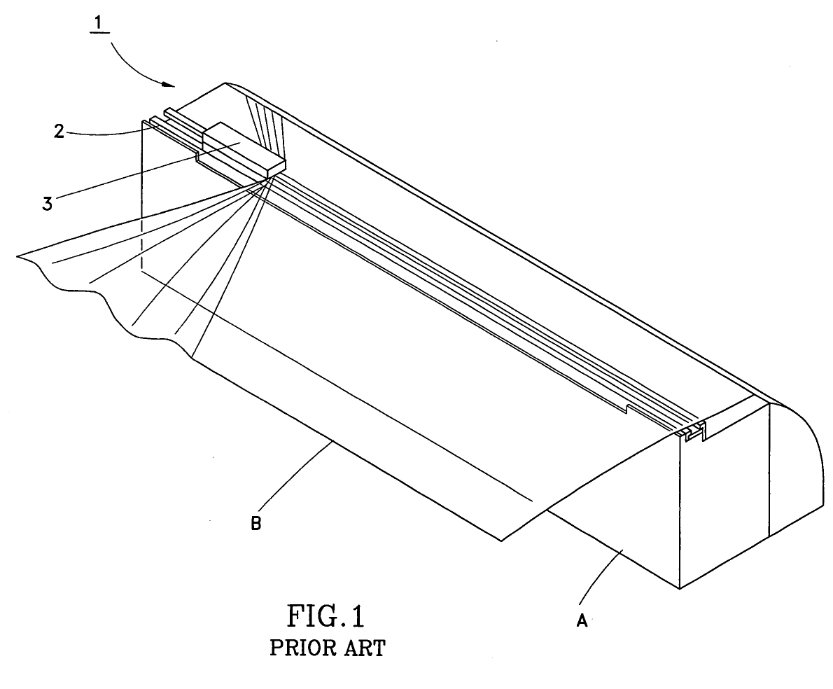

### DETAILED DESCRIPTION OF THE INVENTION

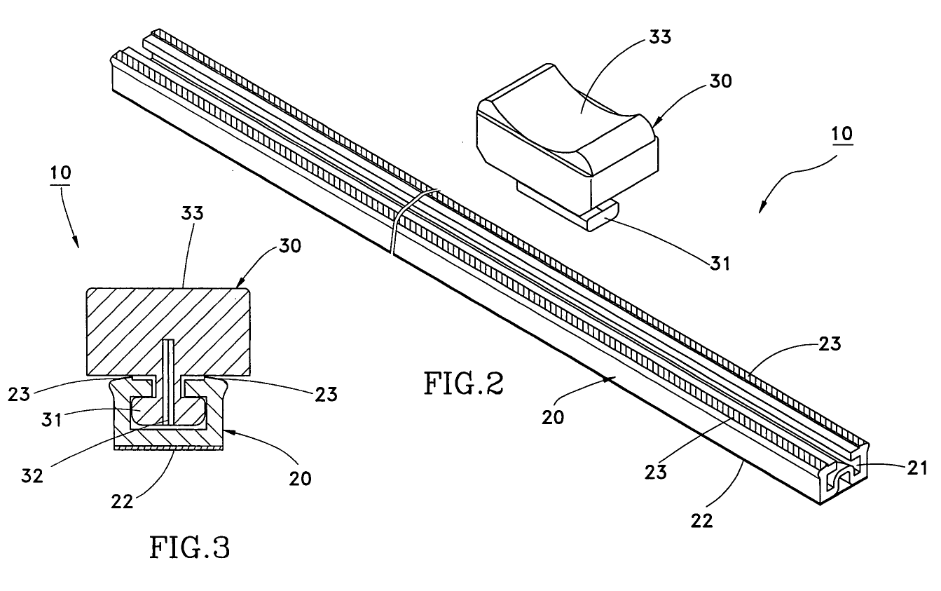

Referring to FIGS. 2 and 3, a wrap film cutting apparatus 10 constructed according to a preferred embodiment of the present invention is mounted on an external side of a wrap film dispenser 40. The cutting apparatus 10 comprises an elongated guide rail 20 and a sliding cutter 30 slidably mounted on the guide rail 20.

The guide rail 20 has an elongated T-shaped guide channel 21 recessed downwards from a top side thereof, an adhesive piece 22 mounted to a bottom side of the guide rail 20 opposite to the guide channel 21 for adhesion to the wrap film dispenser 40, and an attractive layer 23 made of a polymeric material, such as PVC (polyvinyl chloride), and coated onto the top side of the guide rail 20 by extrusion process for attracting a rap film 41 from the wrap film dispenser 40. In practice, the polymeric material that the attractive layer 23 is made is preferably selected from the group consisting of PVC (polyvinyl chloride), PE (polyethylene), PP (polypropylene), EVA (ethylene vinyl acetate), and ABS (acrylonitrile butadiene styrene).

The sliding cutter 30 has a T-shaped sliding portion 31 slidably fitted to the guide channel 21 for relative sliding, a blade 32 covertly mounted in the sliding portion along a long axle thereof for cutting the wrap film 41, and an arched saddle 33 mounted above the sliding portion 31 for holding and pushing by the user's hand.

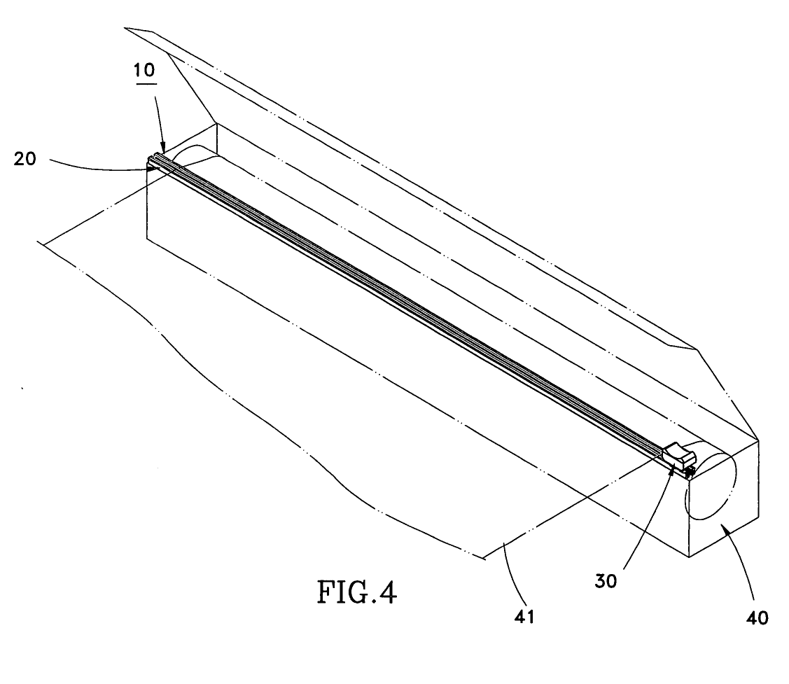

Referring to FIG. 4, the wrap film cutting apparatus 10 is adhered to a side of the wrap film dispenser 40 by the adhesive piece 22. While the user intends to operate the wrap film cutting apparatus 10, the user can pull a section of the wrap film 41 out of the wrap film dispenser 40 and smoothly lay the section of the wrap film 41 on the top side of the guide rail 30 over the guide channel 21. In the meantime, because the polymeric material is qualitatively similar to the wrap film, when the attractive layer closely approaches the wrap film, attraction is generated between them to keep the wrap film 41 being smoothly adhered to the attractive layer. Accordingly, the user can hold the sliding saddle 30 and push the sliding cutter slidably along the guide channel 21 to easily cut the wrap film by the sliding cutter 32, thereby causing rapid, smooth, and stable cutting action and being preferably convenient for the user.

1. An apparatus for cutting a wrap film, said apparatus comprising a guide rail and a sliding cutter, said sliding cutter being slidably mounted on said guide rail and having a blade, said guide rail having an attractive layer made of a polymeric material and coated on a top surface thereof corresponding to said sliding cutter for attracting said wrap film.

2. The apparatus as defined in claim 1, wherein said guide rail comprises a T-shaped guide channel recessed downwards from the top surface thereof; said sliding cutter comprises a T-shaped sliding portion slidably mounted in said guide channel.

3. The apparatus as defined in claim 1, wherein said sliding cutter comprises an arched saddle for pushing by a user.

4. The apparatus as defined in claim 1 further comprising an adhesive piece mounted at a side of said guide rail.

5. The apparatus as defined in claim 1, wherein said attractive layer is made of PVC (polyvinyl chloride).

6. The apparatus as defined in claim 1, wherein said polymeric material that said attractive layer is made is selected from the group consisting of PVC (polyvinyl chloride), PE (polyethylene), PP (polypropylene), EVA (ethylene vinyl acetate), and ABS (acrylonitrile butadiene styrene).

7. The apparatus as defined in claim 1, wherein said attractive layer is coated on said guide rail by extrusion process.

8. An apparatus for cutting a wrap film, said apparatus comprising a guide rail and a sliding cutter, said sliding cutter being slidably mounted on said guide rail and having a blade, said guide rail having an attractive layer coated on a top surface thereof corresponding to said sliding cutter for attracting said wrap film, said attractive layer being made of a polymeric material selected from the group consisting of PVC (polyvinyl chloride), PE (polyethylene), PP (polypropylene), EVA (ethylene vinyl acetate), and ABS (acrylonitrile butadiene styrene).

9. The apparatus as defined in claim 8, wherein said guide rail further comprises a T-shaped guide channel recessed downwards from the top surface thereof; said sliding cutter further comprises a T-shaped sliding portion slidably mounted in said guide channel.

10. The apparatus as defined in claim 8, wherein said sliding cutter further comprises an arched saddle for pushing by a user.

11. The apparatus as defined in claim 8 further comprising an adhesive piece mounted at a side of said guide rail.
